(19) United States
(12) Patent Application Publication
(10) Pub. No.: US 2005/0078089 A1
(43) Pub. Date: Apr. 14, 2005

(54) Computer mouse with multimedia hotkeys and processing method thereof

(76) Inventor: Wen-Hsiu Kuo, SAN CHUNG CITY (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/998,767

(22) Filed: Nov. 29, 2004

Related U.S. Application Data
(63) Continuation-in-part of application No. 10/052,542, filed on Jan. 23, 2002.

(51) Int. Cl. G09G 5/08

(52) U.S. Cl. 345/163

(57) ABSTRACT

A computer mouse with multimedia hotkeys is provided. The computer mouse includes a mouse body, an input portion for selecting computer functions, a mouse motion tracking mechanism for moving the mouse body, a circuit board for controlling the mouse operations, a peripheral interface for transmitting data processed by the circuit board to a computer, and at least one multimedia hotkey. When one single multimedia hotkey is depressed, the make code encoded by the pre-set data format program of the circuit board is transmitted to the computer through the peripheral interface for executing an associated multimedia program.

### CROSS-REFERENCE TO RELATED APPLICATION

This application is a continuation-in-part of U.S. application Ser. No. 10/052,542, filed on Jan. 23, 2002, hereby incorporated by reference as it fully set forth herein.

### FIELD OF THE INVENTION

The present invention relates to the feature of a computer mouse and a processing method of the computer mouse, and more particularly, to the computer mouse with built-in multimedia hotkeys and the processing method thereof.

### BACKGROUND OF THE INVENTION

The mouse is an essential input device for contemporary computer operations. Users may select icon function by the cursor, and grip the mouse body under their palms to slide, and depress the buttons by their fingers. The cursor is used to indicate locations of icon according to the movement of the mouse body.

A computer mouse is an indispensable peripheral device for computer operation. So far, the computer mouse presented in the market merely uses a cursor to control computer functions. After operating the computer for a certain period of time, a user is easily to have sore arms and palms, causing the inconvenience of operation. Especially, the current computer system and application software are stronger and stronger, and the application scopes thereof are broader and broader, not only being applied in word processing, but also being widely applied in the multimedia field that is closely related to daily life, particularly in other window application software such as Internet, E-mail, music and film playing, image/sound conversion, etc. Hence, it is more and more frequently for the user to select or switch the functions between applications, so that it is very inconvenient to select the computer functions with a common computer mouse. In order to overcome the aforementioned problem, the present invention provides a computer mouse that does not need to use a cursor to perform computer functions, and is an inventive device for brief and simple usability and operation. The present invention is to install multimedia hotkeys on the computer mouse main body and to equip the computer mouse with the operation methods of special functional hotkeys, so that the computer mouse does not need to rely on the cursor movement to control the computer functions. When the user presses down one of the multimedia hotkeys, the computer will directly perform the multimedia function corresponding thereto.

Hinckley et al. (U.S. patent 2001/0,015,718A1) disclosed input devices in a computer system which have a touch sensitive auxiliary controls need to cooperated with a displaying widget for window software on the monitor screen for providing a processing method, detecting a physical presence when a user's hand approaches a touch sensitive auxiliary control for a first predefined, then responsive to displaying a widget on the monitor screen providing a current control state of status information. If detecting absence of the physical presence proximate to the touch sensitive auxiliary control for a second predefined while displaying the display widget, then deter g and executing the application program if a pointer is located within displaying the display widget. Although Hinckley et al. have sort of enhanced the mouse functionality, yet Hinckley's mouse merely has the multimedia hotkeys that cannot directly execute multimedia application programs but is operated through various predefinition levels of the display widget and associated with a pointer to point the widget within. With regard to Hinckley's mouse, the control functions need to cooperate with the Window software of widget and GM (Graphic User Interface) display to show status information on the display screen responsive to the detection of a physical presence of the control sensor, and through a pointer (cursor) is moved to locate within the widget and GUTI of function area; A display widget software is a special Window software of application program for providing a user's special interface tool box including a GIU (graphical user interface) Wherein a touch sensor are coated with separate conductive films in a mouse surface including a palm, a button key, a wheel as a auxiliary control, etc., and the sensor output is an analog signal first transmitted to an analog-to-digital (A/D) converter and multiplexer, and then the A/D multiplexer outputs a digital signal to a microprocessor. Thus, Hinckley's mouse does not have the direct hotkey function and is inconvenient for users, and has a relatively complicated structure (including a circuit and a mechanism) and operation method, thus resulting in the defect of operation inconvenience and inefficiency, and higher fabrication cost.

Therefore, there is a need to develop a computer mouse with built-in multimedia hotkeys and a processing method thereof, so as to save the space of computer keyboard, and to provide users with convenient operation, thus adding mouse functionality and reducing fabrication cost.

### SUMMARY OF THE INVENTION

Therefore, it is a primary object of the present invention to provide a computer mouse with pre-setup (built-in) multimedia hotkeys and a processing method thereof, so that a user can execute multimedia programs and Internet related applications merely by using the computer mouse.

It is another object of the present invention to provide a computer mouse with pre-setup (built-in) multimedia hotkeys and a processing method thereof, thereby providing a simple structure for reducing fabrication cost and saving the space of computer keyboard.

According to the aforementioned objects, a computer mouse and a processing method thereof are provided for directly executing the multimedia application programs in a computer.

According to an embodiment of the present invention, the computer mouse includes a mouse body, an input portion including at least one general function key for selecting computer functions; a mouse motion tracking mechanism for moving a computer cursor responsive to movement of the mouse body; a circuit board for controlling operations of the mouse device, wherein at least one pre-set data format program is deployed on the circuit board in the form of internal code; a peripheral interface for transmitting data processed by the circuit board to a computer; and at least one multimedia hotkey mounted on the mouse body and connected to the circuit board, wherein the at least one pre-set data format program of the circuit board is associated and corresponding with the at least one multimedia hotkey. When the multimedia hotkey is depressed, at least one pre-set data is encoded by the at least one pre-set data format program of the circuit board, and is transmitted to the computer through the peripheral interface so as to enable the computer to execute the at least one multimedia application program.

Further, the at least one pre-set data format program is pre-installed as computerware selected from hardware and firmware into the circuit board.

Moreover, the general function key can act as both normal general function keys and the multimedia hotkeys with the addition of a switch key mounted on the computer mouse.

According to the embodiment of the present invention, a multimedia hotkeys control program is stored into memory of a microprocessor in a computer mouse so as to execute multimedia application programs in the computer, and, the processing method of the computer mouse with a plurality of multimedia hotkeys comprises: communicating with the computer and setting the communication data format between the computer mouse device and the computer; scanning and detecting if one of the multimedia hotkeys is pressed; generating a scan code signal of the one of the multimedia hotkeys when the one of the multimedia hotkeys is pressed; storing the scan code signal into a system message buffer; and sending the scan code signal to the computer for executing a corresponding multimedia application program.

Hence, with the application of the present invention, a user can execute multimedia programs and Internet related applications merely by using the computer mouse; a simple mouse structure with multimedia hotkeys is provided for reducing fabrication cost and saving the space of computer keyboard.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a perspective view of a computer mouse according to one preferred embodiment of this invention;

FIG. 2 is a flow chart illustrating the processing method of the mouse in accordance with the present invention; and

FIG. 3A is a top view of a computer mouse according to the other preferred embodiment of this invention;

FIG. 3B is a side view of a computer mouse according to the other preferred embodiment of this invention; and

FIG. 3C is a front view of a computer mouse according to the other preferred embodiment of this invention.

### DETAILED DESCRIPTION OF THE PREFERRED EMBODIMENT

The present invention is featured in installing one or more multimedia hotkeys on a computer mouse and internally coding associated pre-set data format programs on a circuit board of the computer mouse, so as to execute a corresponding multimedia application program by pressing one single multimedia hotkey.

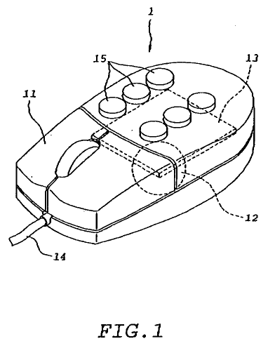

Please refer to FIG. 1. FIG. 1 is a perspective view of a computer mouse according to one preferred embodiment of this invention. As shown in FIG. 1, the computer mouse includes a mouse body 1, an input portion 11, a mouse motion tracking mechanism 12, a circuit board 13 located inside the mouse body 1, a peripheral interface 14, and a plurality of multimedia hotkeys 15 mounted on the top surface of the mouse body 1.

The circuit board 13 is mounted within the mouse body 1. The circuit board 13 has a microcontroller unit (not shown) for data encoding, signal processing, and mouse operation control. When the mouse body 1 is moved to an intended icon on the computer screen by the cursor and the input portion 11 detects general function keys are pressed, these signals will be processed by the circuit board 13 and sent to a computer (not shown).

The multimedia hotkeys 15 are connected to the circuit board 13, and pre-set data format programs associated with the multimedia hotkeys are installed on the circuit board 13 in the form of internal code. It is worthy to be noted that pre-set data format program can be pre-installed as computerware, such as hardware or firmware into the circuit board. Thus, the computer mouse of the present invention is a complete and independent product, which can be plugged in and played on any computer without needing to cooperate with the Window software of widget or GUI (Graphic User Interface) display. When the user presses one of the multimedia hotkeys 15, a make code encoded and processed by a pre-set data format program the circuit board 13 are transmitted to the computer through the peripheral interface 14 for executing an associated multimedia program.

The input portion 11 includes at least one general function key and a wheel axis as known in the art. A computer user generally grips the mouse body 1 under his palm and rests his index or middle finger on the general function keys. Afterward, the computer user can employ his wrist to move the cursor on the screen, and to execute relative application programs when the general function key is depressed. On the other hand, the general function key of the input portion 11 also can act as the multimedia hotkeys with the addition of a switch key (not shown) mounted on the computer mouse. The switch key is operated in a plurality of operation modes, such as a general-function mode, and a multimedia mode. When the switch key is in the general-function mode, the general function key acts as general function key normally. When the switch key is in the multimedia mode, the general function key turns into multimedia hotkey 15 as described above. Additionally, a LED indicator (not shown) can be installed to show the status of the switch key.

The mouse motion tracking mechanism 12 may include a wheel ball Or optical lens. The movement of the computer mouse may be detected by such as the combination of the wheel ball and IR_PTR or the optical lens and an optical sensor of the interface device.

The peripheral interface 14 can be a serial type connector (as shown in FIG. 1), PS2 connector, or USB connector. Alternatively, the peripheral interface 14 may be a wireless or wired interface. The wireless interface may be a radio-frequency or infrared communication module. It is known that such wireless transmission has to incorporate with a receiver connected to the computer for relaying corresponding signals and data decoding. The main purpose of the periphery interface 14 is to transmit data processed by the circuit board 13 to the computer. Moreover, texts or symbols showing the function corresponding to the at least one multimedia hotkey can be printed on surface of the at least one multimedia hotkey, or shown on a screen display, for users' operation convenience.

It is worthy to be noted that the input device of the computer mouse can be at least one specific multimedia hotkey, the general function keys of the computer mouse, wherein the general function keys can be configured to the operation mode of multimedia hotkeys; or the scroll wheel of the computer mouse, wherein the scroll wheel can be configured to the operation mode of multimedia hotkeys, or the operation mode of simulating keyboard Further, the input device of the computer mouse can be operated in a rolling mode, a swaying mode, a seesaw mode or a pressing mode. Moreover, the input device of the computer mouse can be a switch key, a rubber key, an encoder switch or a photoelectric part.

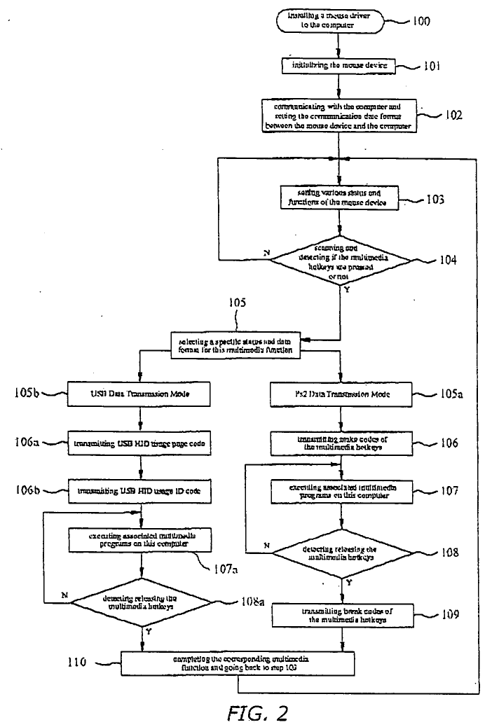

Please refer to FIG. 2. FIG. 2 is a flow chart illustrating the processing method of the mouse in accordance with the present invention. The processing method including following steps are described hereinafter:

The computer mouse of the present invention at least has an input device including general fiction keys, a scroll wheel and specific multimedia hotkeys combined with a multimedia hotkeys control program and scan codes corresponding to the multimedia hotkeys, each of the multimedia hotkeys having its own scan code used for defining various multimedia functions, and the multimedia hotkeys control program is stored into memory of a microprocessor in a computer mouse, so as to execute the multimedia application programs in the computer. At first, Step 100 is performed for installing a mouse driver in the computer for the first time only. The, Step 101 is performed for initializing the computer mouse device. Thereafter, Step 102 is performed for communicating with the computer and setting the communication data format between the computer mouse device and the computer.

Thereafter, Step 103 is performed for being ready to set various status and functions of the computer mouse device Then, Step 104 is performed for scanning and detecting if the multimedia hotkeys are pressed. If the result of Step 104 is no, then the computer mouse returns to Step 103. If the result of Step 104 is yes, a scan code signal of a certain multimedia hotkey pressed is generated, and then Step 105 is performed for selecting a specific status and data format for the multimedia function, wherein the multimedia hotkeys control program stores the scan code signal into a system message buffer, and then sends the scan code signal to the computer for executing the multimedia application programs.

If a PS2 data transmission mode is selected (Step 105a), make codes associated with the pressed multimedia hotkeys are generated by the pre-set data format programs of the circuit board inside the computer mouse, and then Step 106 is performed for transmitting make codes whenever any a multimedia hotkey is pressed. Thereafter, Step 107 is performed for executing associated multimedia program on this computer. Step 108 is performed for detecting if the multimedia hotkeys are released Step 109 is then performed for transmitting break codes if the result of the Step 108 is yes. Then, the function of the multimedia hotkey is completed (Step 110), and the computer mouse returns to Step 103 for being ready to receive next pressed multimedia hotkeys. If the result of Step 108 is no, the computer mouse returns to Step 107. It is noted that the scan code of the multimedia hotkey is called a make code when the multimedia hotkeys is pressed; and the scan code of the multimedia hotkey is called a break code when the multimedia hotkeys is released.

If a USB data transmission mode is selected (Step 105b), ED usage and ED codes (hotkey ED code) associated with the pressed multimedia hotkeys are generated by the pre-set data format programs of the circuit board inside the computer mouse, and then Step 106a is performed for transmitting a usage page code, and then Step 106b is performed for transmitting a HD usage D code. Thereafter, Step 107a is performed for executing associated multimedia program on this computer. Step 108a is performed for detecting if the multimedia hotkeys are released. If the result of Step 108a is yes, the function of the multimedia hotkey is completed (Step 110), and then the computer mouse returns to Step 103 for being ready to receive next pressed multimedia hotkeys. If the result of Step 108a is no, the computer mouse returns to Step 107a.

The make codes and break codes are not limited to being generated in the PS2 data transmission mode, and also can be applied in the USB data transmission mode. The HID usage ID code and HID usage page code are not limited to being generated in the USB data transmission mode, and also can be applied in the PS2 data transmission mode. Therefore, the present invention is not limited thereto.

In the aforementioned steps, a window application program will determine if the scan code signal sent is an expansion code that is an E0 code or a HID usage ID code, and if the result is yes, then the computer will execute the associated multimedia application program. Further, the scan codes corresponding to the multimedia hotkeys adopts keyboard of standard keys code combing with application-specific expansion codes for E0 code to define the functions of the multimedia hotkeys.

If the scan code stored in the computer mouse is an external code that is not recognizable to the computer, it is a manufacturer-specific code (i.e. made by other vendors), so that it is necessary to install a driver software in advance for converting the external code to an internal code acceptable to the computer, wherein the internal code contains the application expansion code or the hotkey ID code.

In contrast to the prior art, the present invention provides a computer mouse having pre-setup built-in hotkeys for executing multimedia programs directly. Furthermore, the user can link Internet, receive or send i-mails, and play VCDs/DVDs and music including CD and other application specific function by just pressing these hotkeys and does not need to use the keyboard anymore.

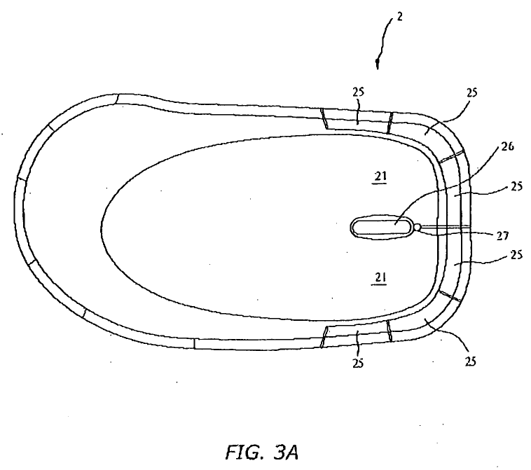

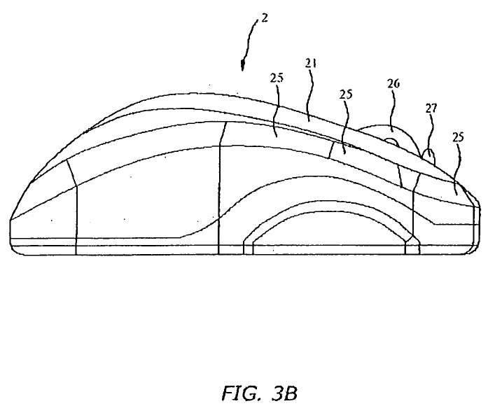

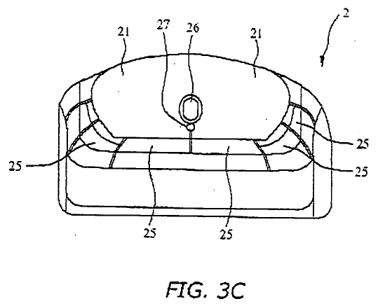

It is worthy to be noted that the multimedia hotkeys of the present invention not only can be located on the positions as shown in FIG. 1, but also can be located on any proper areas of the mouse body. Referring to FIG. 3A, FIG. 3B and FIG. 3C, FIG. 3A, FIG. 3B and FIG. 3C are a top view, a side view and a front view of a computer mouse according to the other preferred embodiment of this invention. The computer mouse includes a mouse body 2, an input portion 21, a scroll wheel 26 used for scrolling a screen page, a switch key 27 and a plurality of multimedia hotkeys 25 mounted on the top surface of the mouse body 2. The multimedia hotkeys 25 are located on the front edge of the mouse body 2, and the switch key 27 is located on the front end of the scroll wheel adjacent to the multimedia hotkeys 25. Consequently, users can operate the switch key 27, the multimedia hotkeys 25 and the scroll wheel 26 conveniently.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

1. A processing method of a computer mouse with a plurality of multimedia hotkeys, the computer mouse at least having an input device combined with a multimedia hotkeys control program and scan codes, wherein the multimedia hotkeys control program is stored into memory of a microprocessor in a computer mouse, so as to execute multimedia application programs in the computer, and the processing method is a hotkey operation method, the input device comprising general function keys, a scroll wheel of the computer mouse and specific multimedia hotkeys, the processing method comprising:
communicating with the computer and setting the communication data format between the computer mouse device and the computer;
scanning and detecting if one of the multimedia hotkeys is pressed;
generating a scan code of the one of the multimedia hotkeys when the one of the multimedia hotkeys is pressed, each of the multimedia hotkeys having its own scan code used for defining various multimedia functions;
sending the scan code to the computer for executing a corresponding multimedia application program; and
determining by a window application program to ascertain if the scan code is a scan code belonging to the multimedia hotkeys, and when the result is yes, then the computer executes the corresponding multimedia application program.

2. The processing method of claim 1, wherein the scan codes corresponding to the multimedia hotkeys utilizes keyboard of standard keys code combing with application-specific expansion codes for E0 code to define the functions of the multimedia hotkeys.

3. The processing method of claim 1, wherein the scan code of the one of the multimedia hotkeys is called a make code when the one of the multimedia hotkeys is pressed, and is transmitted to the computer for executing the corresponding multimedia application program; and
the scan code of the one of the multimedia hotkeys is called a break code when the one of the multimedia hotkeys is released, and is transmitted to the computer for ending the corresponding multimedia application program.

4. The processing method of claim 1, wherein the scan code of the one of the multimedia hotkeys includes a HID usage D code combined with a HID usage page code, and the HID usage Page code is used to define peripheral device class, and the HID usage ID code is used to define applicant-specific of key code.

5. The processing method of claim 4, wherein, when the HID usage page code is set to a consumer page code while in operation, the HD usage page code is OC; when the HI usage page code is set to keyboard page code while in operation, the HID usage page code is 07; and when the B usage page code is set to generic desktop controls page code while in operation, the HI: usage page code is 01.

6. The processing method of claim 4, wherein when the HID usage page code is set to a consumer page code while in operation, the HD usage ID code of the one of the multimedia hotkeys is composed of two bytes selected from the group consisting of 00 code, 01 code and 02 code.

7. The processing method of claim 1, wherein the computer is preinstalled with driver software for converting the scan code of the one of the multimedia hotkeys to the code acceptable to the computer

8. The processing method of claim 1, wherein the input device includes at least one specific multimedia hotkeys.

9. The processing method of claim 1, wherein the general function keys are configured to the operation mode of multimedia hotkeys.

10. The processing method of claim 1, wherein the scroll wheel is configured to the operation mode of multimedia hotkeys.

11. The processing method of claim 1, wherein the scroll wheel is configured to the operation mode of simulating keyboard.

12. The processing method of claim 1, wherein the input device is operated in a rolling mode, a swaying mode, a seesaw mode or a pressing mode.

13. The processing method of claim 1, wherein the one multimedia hotkeys are located on the edge of the mouse body of the computer mouse.

14. The processing method of claim 1, wherein the input device includes a switch key, a rubber key, an encoder switch or a photoelectric part.
